(19) United States
(12) Patent Application Publication
(10) Pub. No.: US 2020/0113156 A1
(43) Pub. Date: Apr. 16, 2020

(54) Collar with removable flea collar sleeve

(71) Applicant: David Copeland, Princeton, TX (US)

(72) Inventor: David Copeland, Princeton, TX (US)

(21) Appl. No.: 16/157,860

(22) Filed: Oct. 11, 2018

(51) Int. Cl. A01K 27/00

(52) U.S. Cl. CPC A01K 27/007; A01K 27/006; A01K 27/001

(57) ABSTRACT

The invention is a collar with a removable flea collar sleeve. The invention is comprised of a conventional collar to be worn by the pet, which provides an inner flea collar sleeve. The collar provides a sturdy, protective outer layer and may provide decorative features. The sleeve is available separately in a broad variety of sizes, such that users may elect to affix the sleeve within other pet collars.

This application relates back to, and claims the priority of Provisional Patent Application No. 62/610,358 filed on Dec. 26, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to pet care supplies and accessories, and in particular to a collar with a removable flea collar sleeve. Keeping a dog or other pet free from fleas and similar parasites can be very challenging. Generally, pets easily become infested with such parasites and pet owners must apply countermeasures consistently. Flea collars are very useful, but must be changed in a timely manner and held close to the pet's skin or they are ineffective.

A search of the prior art reveals various devices which have been developed to address this set of problems, or related problems. None are closely related to the present invention, but several include features which resemble those of the present invention. Each has proven to be less than satisfactory for the present purpose in its own way.

Pet collar with replaceable insecticide element, U.S. Patent Appl. No. 2008/0008731 (priority Jul. 7, 2006), provides a semi-flexible insecticide strip which is removably attached to the belt of a pelt collar to regenerate a pest-killing medicament and increase its efficacy. The strip is secured to the belt surface that faces the animal skin or fur by attachment loops or edged retainers that are generally perpendicular to the length direction of the belt. Due to the geometry and elasticity of the semi-flexible insecticide strip, and its attachment method, the strip contacts the skin or fur of the animal despite movement of the pet collar when the animal is being exercised with a pet leash attached thereto. The contact effectively transfers the insecticide and kills ticks and fleas or retards development of mature flea adults. The insecticide is contained within a plurality of plastic pores of the insecticide strip or in a sponge affixed thereto.

Animal collar with removable insect strip, U.S. Pat. No. 5,529,019 (priority Sep. 29, 1994), provides an animal collar having an elongated, flexible strap with opposite ends mounting detachable fasteners such as prongs, buckles or the like. Adjacent to each end of the strap, there is provided an open-ended pocket. A pest or insect repellent strip is removably carried on the inside of the collar whereby the opposite ends of the strip are insertably received through the opening into the interior of each pocket respectively. Retainer loops are carried on the strap between the pockets maintaining the repellent strip in position on the strap. Leash rings are operably carried on the strap to accommodate a walking leash.

Animal collar and stud assembly that promotes animal safety and well-being, U.S. Pat. No. 6,283,065 (priority Nov. 9, 1999), provides a collar stud that can be attached to an animal collar to function as a tag, collar lock, and/or electronic identification device. The stud includes a cap positionable adjacent an exterior of the collar and a base that is positionable adjacent an interior surface of the collar. A linkage interconnects the cap and base in a spaced apart fashion to allow a portion of the collar to be sandwiched between the interconnected cap and base. At least a portion of the linkage extends through an aperture of the collar portion and helps secure the stud to the collar portion. A transponder is preferably incorporated into the stud, wherein the transponder includes a memory storing retrievable information comprising an identification code. The code can be used to access a corresponding data record in a database.

Pet collar, U.S. Pat. No. 4,218,991 (priority Jul. 28, 1978), provides a pet collar with a retainer thereon for reception of a removable, flexible strip. The retainer defines a channel with opposed, flexible flanges extending inwardly over a strip within the channel to confine the strip. The flanges are of a deformable nature for strip removal. A collar is also shown having an integrally formed retainer. An identification strip may also be held in place within the retainer.

Device for securing a vaporizable active substance to an animal collar, U.S. Pat. No. 3,814,061 (priority Feb. 8, 1971), provides a device for securing a vaporizable active substance, such as an insecticide, deodorant, and the like to an animal collar so that the vapors are directed away from the skin of the animal. The device includes a container for the active substance in the shape of a tubular member, envelope or sheath formed of a flexible material or of a hollow medallion. Openings are provided in the container so that they direct the vaporized active substance outwardly away from the animal's skin. Attachment members are secured to the container for fixing it to the animal collar. Alternatively, an adhesive strip can be formed on the inner surface of the container for attaching it to the animal collar.

A collar with a removable flea collar sleeve, providing an inner flea collar sleeve on a conventional collar enabling a user to quickly change the sleeve, would resolve this problem.

### SUMMARY OF THE INVENTION

Accordingly, the invention is a collar with a removable flea collar sleeve. The invention is comprised of a conventional collar to be worn by the pet, which provides an inner flea collar sleeve. The collar provides a sturdy, protective outer layer and may provide decorative features. The sleeve is available separately in a broad variety of sizes, such that users may elect to affix the sleeve within other pet collars.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top view of the first exemplary embodiment, displaying the collar 10, the buckle 11, and the sleeve 12.

FIG. 2 is a side perspective view of the first exemplary embodiment, displaying the collar 10, the buckle 11, and the sleeve 12.

FIG. 3 is a top view of the first exemplary embodiment with the sleeve removed, displaying the collar 10, the buckle 11, the sleeve 12, and the flanges 13.

FIG. 4 is a side perspective view of the first exemplary embodiment with the sleeve removed, displaying the collar 10, the buckle 11, and the sleeve 12.

FIG. 5 is a side perspective view of the first exemplary embodiment configured for wear, displaying the collar 10, the buckle 11, and the sleeve 12.

FIG. 6 is a front perspective view of the first exemplary embodiment configured for wear, displaying the collar 10, the buckle 11, and the sleeve 12.

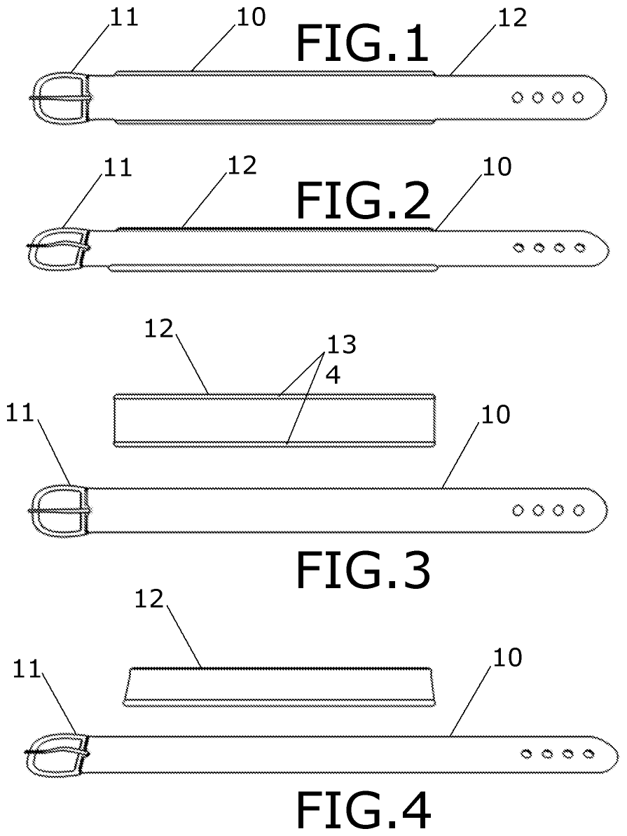

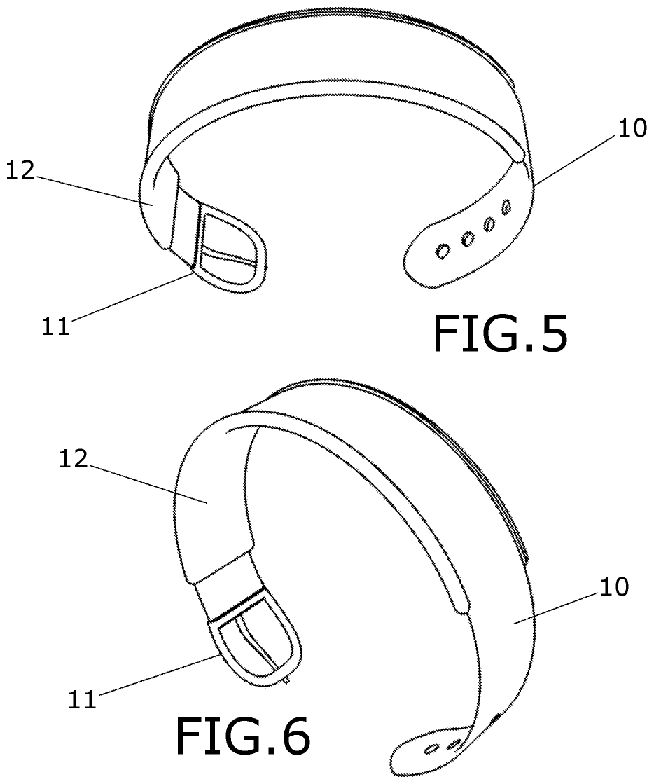

### DETAILED DESCRIPTION OF THE INVENTION

Referring now to the invention in more detail, the invention is a collar 10 with a removable flea collar sleeve 12.

The first exemplary embodiment is comprised of a conventional collar 10 to be worn by the pet, which is secured with a buckle 11. The collar 10 provides an inner flea collar sleeve 12, which provides flanges 13 which may be used to secure the sleeve 12 to the collar 10. The collar 10 provides a sturdy, protective outer layer and may provide decorative features. The sleeve 12 is available separately in a broad variety of sizes, such that users may elect to affix the sleeve 12 within other pet collars.

To use the first exemplary embodiment, the user may remove the collar 10 from the pet, affix the sleeve 12 to the interior surface of the collar 10 using the flanges 13, and replace the collar 10 on the pet.

The collar 10 is preferably manufactured from a flexible, durable material such as plastic, leather, or silicone. The buckle 11 is preferably manufactured from a rigid, durable material, such as steel, aluminum alloy, copper alloy, brass, or plastic. The sleeve 12 is preferably manufactured from a flexible, durable, absorbent material which may be infused with a pest repellent, such as coated foam rubber.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A collar with a removable flea collar sleeve, comprised of a conventional collar to be worn by the pet, which is secured with a buckle, and provides an inner flea collar sleeve, which provides flanges which may be used to secure the sleeve to the collar.

2. The collar of claim 1, wherein the collar provides a sturdy, protective outer layer and may provide decorative features, and the sleeve is available separately in a broad variety of sizes, such that users may elect to affix the sleeve within other pet collars.

3. The collar of claim 1, wherein the user may remove the collar from the pet, affix the sleeve to the interior surface of the collar using the flanges, and replace the collar on the pet.

4. The collar of claim 1, wherein the collar is preferably manufactured from a flexible, durable material such as plastic, leather, or silicone.

5. The collar of claim 1, wherein the buckle is preferably manufactured from a rigid, durable material, such as steel, aluminum alloy, copper alloy, brass, or plastic.

6. The collar of claim 1, wherein the sleeve is preferably manufactured from a flexible, durable, absorbent material which may be infused with a pest repellent, such as coated foam rubber.
